(19) United States
(12) Patent Application Publication
(10) Pub. No.: US 2024/0210539 A1
(43) Pub. Date: Jun. 27, 2024

(54) Method and Device for Recognizing a Decalibration of a Lidar System

(71) Applicant: Daimler Truck AG, Leinfelden-Echterdingen (DE)

(72) Inventors: Chrysa KHOURY, Fellbach (DE); Sebastian KLEINSCHMIDT, Hannover (DE)

(21) Appl. No.: 18/556,526

(22) PCT Filed: Apr. 21, 2022
(86) PCT No.: PCT/EP2022/060475

§ 371 Date: Oct. 20, 2023

(30) Foreign Application Priority Data
Apr. 23, 2021 (DE) 10 2021 002 158.4

(51) Int. Cl. G01S 7/497; G01S 7/481; G01S 17/89; G01S 17/931

(52) U.S. Cl. CPC G01S 7/497; G01S 7/4816; G01S 17/89; G01S 17/931

(57) ABSTRACT

A method for recognizing a decalibration of a lidar system includes scanning an environment by the lidar system with laser receiver systems in a shared viewing region. A flat surface located in the shared viewing region is scanned with the laser receiver systems. Point clouds are identified that are created by a reflection of a respective laser beam of the laser receiver systems on the flat surface. A virtual measuring surface is interpolated by the identified point cloud of the respective laser beam. It is determined whether the virtual measuring surfaces for the respective laser beams substantially coincide with one another and/or are bent. A decalibration of the lidar system is deduced when it is determined that the virtual measuring surfaces for the respective laser beams do not substantially coincide with one another and/or that at least one of the virtual measuring surfaces for the respective laser beams is bent.

### BACKGROUND AND SUMMARY OF THE INVENTION

The invention relates to a method for recognizing a decalibration of a lidar system.

The invention further relates to a device for recognizing a decalibration of a lidar system.

A method for in-operation calibration of a lidar of a vehicle having the following method steps is known from DE 10 2020 007 772 A1:
scanning a vehicle environment several times by means of a lidar to generate point clouds;
monitoring a relative position of scan points comprised by the point clouds relative to the lidar;
determining a movement direction of the scan points by evaluating a relative position shift of the scan points between the point clouds;
determining an intersection point of the movement directions of a pre-determined selection of scan points to determine a current vanishing point;
comparing a position of the current vanishing point with a known position of a reference vanishing point; and
if a position deviation is determined between the current vanishing point and the reference vanishing point: shifting a reference coordinate system or a current coordinate system to superimpose the current vanishing point on the reference vanishing point.

A vehicle having a lidar and a computer is further described, wherein the computer is equipped to carry out the method.

The object of the invention is to specify a new kind of method and a new kind of device for recognizing a decalibration of a lidar system.

In a method according to the invention for recognizing a decalibration of a lidar system, in particular of a lidar system of a vehicle, the lidar system scans an environment, in particular an environment of the vehicle, with several laser receiver systems in a shared viewing region. A flat surface located in the shared viewing region is scanned with the laser receiver systems. Point clouds are identified that are created by the reflection of a respective laser beam of the laser receiver systems on the flat surface. A virtual measuring surface, for example a B-spline plane or a Bezier plane, is interpolated by the identified point cloud of the respective laser beam. It is determined whether the measuring surfaces determined for the respective laser beams substantially coincide with one another and/or are bent.

If it is determined that the measuring surfaces determined for the respective laser beams do not substantially coincide with one another and/or that at least one of the measuring surfaces determined for the respective laser beams is bent, a decalibration of the lidar system is deduced, i.e., the decalibration of the lidar system is then recognized.

A device according to the invention for recognizing a decalibration of a lidar system, in particular of a lidar system of a vehicle, in particular for carrying out the previously specified method for recognizing the decalibration of the lidar system, in particular of the lidar system of a vehicle, wherein the lidar system has several laser receiver systems that are designed and equipped to scan an environment, in particular an environment of the vehicle, in a shared viewing region is designed and equipped to scan a flat surface located in the shared viewing region with the laser receiver systems, to identify point clouds that are created by the reflection of a respective laser beam of the laser receiver systems on the flat surface, to interpolate a virtual measuring surface, for example a B-spline plane or a Bezier plane, with the identified point cloud of the respective laser beam, to determine whether the measuring surfaces determined for the respective laser beams substantially coincide with one another and/or are bent, and to deduce a decalibration of the lidar system, i.e., to recognize the decalibration of the lidar system, if it is determined that the measuring surfaces determined for the respective laser beams do not substantially coincide with one another and/or that at least one of the measuring surfaces determined for the respective laser beams is bent.

The lidar system to be checked by means of the method or of the device with regard to a decalibration that is potentially present is thus designed as such a lidar system having several laser receiver systems that have a shared viewing region. As previously specified, the lidar system scans the environment, in particular the environment of the vehicle, with several laser receiver systems in a shared viewing region. It thus scans the environment, in particular the environment of the vehicle, with several laser beams in the shared viewing region, wherein the respective laser beam is generated and emitted by the respective laser receiver system, and reflected radiation of the respective laser beam, in particular caused by the objects reflecting the laser beam, is received by the receiver of the receiver laser system. The respective laser receiver system is thus a laser transmitter-receiver system.

To enable the described scanning in the shared viewing region, viewing regions of the individual laser receiver systems overlap at least in some regions, wherein an overlap region in which the viewing regions of the individual laser receiver systems overlap forms the shared viewing region. The lidar system comprises at least two or more than two such laser receiver systems. Such a lidar system is also described as a multi-eye lidar system.

The lidar system thus scans the environment, in particular the environment of the vehicle, as described with several laser receiver systems and thus with several laser beams, specifically with the laser beam of the respective laser receiver system, in the shared viewing region. To recognize a possible decalibration, the flat surface located in the shared viewing region is scanned with the laser receiver systems, and thus with the several laser beams, specifically with the laser beam of the respective laser receiver system. The point clouds that are created by the reflection of the respective laser beam on the flat surface are identified. A virtual measuring surface, for example a B-spline plane or a Bezier plane, is interpolated by the identified point cloud of the respective laser beam, i.e., the respective virtual measuring surface is interpolated by means of all the points of the respectively identified point cloud. The respective virtual measuring surface thus advantageously runs through all the points of the respectively identified point cloud. It is determined whether the measuring surfaces determined for the respective laser beams substantially coincide with one another and/or are bent. If it is determined that the measuring surfaces do not substantially coincide with one another and/or that at least one of the measuring surfaces is bent, a decalibration of the lidar system is deduced.

It can be ensured via the solution according to the invention that the lidar system operates within pre-determined parameter limits and only deviates from accepted, in particular pre-determined, models within permissible limits. Only via calibrated lidar systems, in particular multi-eye lidar systems, can a safe operation of automated, in particular highly automated or autonomous vehicles be ensured.

The solution according to the invention in particular enables an automatic recognition of the decalibration of the lidar system even outside of workshops and testing facilities, i.e., for example in a vehicle that is with a vehicle user, for example during a normal driving operation and/or before and/or after such a normal driving operation during a standstill of the vehicle. Thus, for example, maintenance intervals of the lidar system can be increased and/or no maintenance of the lidar system, for example by a workshop, needs to be carried out to recognize such a decalibration of the lidar system.

If the presence of a decalibration is recognized by means of the solution according to the invention, it can for example be provided that systems and functions based on the lidar system are deactivated or only operated to a limited extent. As an alternative or in addition, the vehicle user can for example be informed about the recognized decalibration of the lidar system, for example via a corresponding optical, acoustic and/or haptic warning, and/or maintenance of the lidar system can be arranged, for example an automatic booking of a maintenance appointment in a workshop, or such a booking of a maintenance appointment can be suggested to the vehicle user by the vehicle, whereby, for example, they can be supported in this booking by the vehicle or can arrange for it to be carried out automatically.

As an alternative or in addition, a calibration of the lidar system can, for example, be carried out after a decalibration of the lidar system has been recognized, by adjusting the points to a shared plane by using a suitable model, i.e., such that all the points of all the point clouds that are created in the shared viewing region by the reflection of the respective laser beam of the laser receiver systems at the flat surface that is located in the shared viewing region of the laser receiver systems and that is scanned by these lie in a shared plane. A corresponding method for calibrating the lidar system, in particular the lidar system of a vehicle, thus comprises the method described here for recognizing a decalibration of a lidar system, in particular a lidar system of a vehicle, and additionally, when a decalibration of the lidar system is recognized, its calibration is adjusted in the manner described above, i.e., the points are adjusted to a shared plane, in particular in the manner described above, by using a suitable model. A corresponding device for calibrating the lidar system, in particular the lidar system of a vehicle, in particular for carrying out the method for calibrating the lidar system, correspondingly comprises the device described here for recognizing a decalibration of the lidar system, in particular of a lidar system of the vehicle, and is additionally designed and equipped to calibrate the lidar system in the manner described above when its decalibration is recognized, i.e., is designed and equipped to adjust the points to a shared plane, in particular in the manner described above, by using a suitable model. Via this possibility of calibrating the lidar system after decalibration is recognized, workshop visits for maintaining the lidar system can be avoided, and the lidar system can be very quickly recalibrated and then be used without limitation again in the manner described, in particular automatically. Downtime of the lidar system and limitations of systems and functions of the vehicle resulting from the latter can thus be reduced to a minimum, and inconveniences and increased effort for the vehicle user can be avoided.

In a possible embodiment of the method, to determine whether the respective measuring surface is bent, a tangential plane is determined on the respective measuring surface at each point of the point cloud that determines this respective measuring surface. A tangential plane of this respective measuring surface is thus determined at each of these points of the respective measuring surface, i.e., a plane abutting tangentially on the respective point of the respective measuring surface on the respective measuring surface. A respective bent measuring surface is deduced, i.e., it is determined that the respective measuring surface is bent, if the tangential planes determined for the different points of the respective measuring surface do not substantially coincide with one another. As described above, a decalibration of the lidar system is deduced already, i.e., such a decalibration of the lidar system is recognized, if at least one of the measuring surfaces is bent, i.e., if the tangential planes determined for the different points of this measuring surface do not substantially coincide with one another in at least one of the measuring surfaces.

In a possible embodiment of the device, the device for determining whether the respective measuring surface is bent is designed and equipped to determine a tangential plane on the respective measuring surface at each point of the point cloud that determines this respective measuring surface, and to deduce a respective bent measuring surface, i.e., to determine that the respective measuring surface is bent if the tangential planes determined for the different points of the respective measuring surface do not substantially coincide with one another. As described above, a decalibration of the lidar system is deduced already, i.e., such a decalibration of the lidar system is recognized, if at least one of the measuring surfaces is bent, i.e., if the tangential planes determined for the different points of this measuring surface do not substantially coincide with one another in at least one of the measuring surfaces.

The embodiment described of the determination of whether the respective measuring surface is bent is a simple, efficient and safe possibility for this determination.

The flat surface is advantageously at least as large as the shared viewing region of the laser receiver systems. The flat surface is advantageously larger than the shared viewing region of the laser receiver systems, i.e., it advantageously protrudes completely over the shared viewing region at the edge. The flat surface, and thus advantageously an object having the flat surface, and the lidar system are or have been advantageously aligned with each other such that the shared viewing region lies entirely on the flat surface.

In a possible embodiment, a calibration target, a house wall or a traffic sign or an object that has this flat surface is used as a flat surface. By using a pre-determined calibration target, i.e., calibration target object, as a flat surface, it can be easily ensured that a flat surface is actually scanned in the manner described above. This can for example take place in a workshop, but can also be carried out by a vehicle user during a normal use of the vehicle by the vehicle user positioning the calibration target in the shared viewing region of the laser receiver systems. A workshop visit or maintenance of the lidar system by specific maintenance personnel is thus not necessarily required for this purpose. The further possibilities of using a house wall or a traffic sign as a flat surface enable this to be carried out even more easily, such that the recognition of the possible decalibration can be carried out particularly easily even outside of workshops, and without specific maintenance personnel, for example by a vehicle user during a normal use of the vehicle or automatically in a particularly advantageous manner, such that there is no associated effort for the vehicle user.

The phrasing “substantially coincide with one another” used above should in particular be understood to mean that deviations that are potentially present lie within pre-determined tolerance limits, i.e., the measuring surfaces determined for the respective laser beams substantially coincide with one another if determined deviations lie within these pre-determined tolerance limits. If this is the case then the measuring surfaces determined for the respective laser beams are evaluated as, at least substantially, coinciding with one another. If deviations are determined that do not lie within these pre-determined tolerance limits, i.e., exceed these pre-determined tolerance limits, then the measuring surfaces determined for the respective laser beams are evaluated as not coinciding with another, and also as not substantially coinciding with one another.

Exemplary embodiments of the invention are explained in more detail in the following with reference to the drawings.

### BRIEF DESCRIPTION OF THE DRAWINGS

FIG. 1 schematically shows a side view of a traffic situation with two vehicles;

FIG. 2 schematically shows a scan trajectory of a laser receiver system of a lidar system;

FIG. 3 schematically shows scan trajectories of two laser receiver systems of a multi-eye lidar system;

FIG. 4 schematically shows scan trajectories of two laser receiver systems of a multi-eye lidar system having a shared viewing region; and

FIG. 5 schematically shows a device for recognizing a decalibration of a lidar system, in particular of a lidar system of a vehicle, in particular for carrying out a method for recognizing the decalibration of the lidar system, in particular of the lidar system of a vehicle.

### DETAILED DESCRIPTION OF THE DRAWINGS

Parts corresponding to one another are provided with the same reference numerals in all figures.

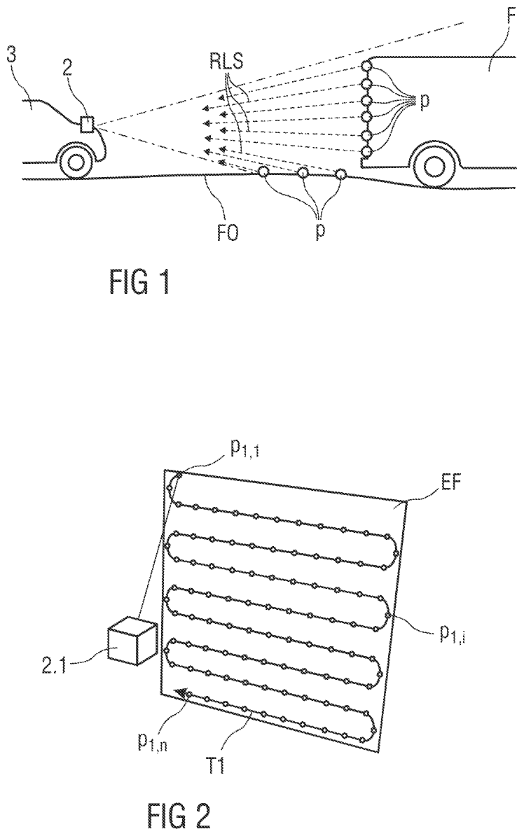

With reference to FIGS. 1 to 5, a method and a device 1 for recognizing a decalibration of a lidar system 2, in particular of a lidar system 2 of a vehicle 3, are described in the following, wherein the device 1 is advantageously designed and equipped to carry out the method. The method and the device 1 in particular enable the recognition of an intrinsic decalibration, in particular of a multi-eye lidar system.

Lidar or LiDAR is an abbreviation for “Light Detection and Ranging”, and means “optical spacing measurement”. Lidar is a similar measuring method to radar of measuring the distance, location and intensity of an object in the vicinity, i.e., in a vicinity of the lidar system 2. For example, it uses ultra-violet beams, infra-red beams and beams from the range of visible light. For this purpose, light pulses can for example be used, and a distance to an object can be calculated via a duration measurement of the light. This measurement technique is called amplitude modulated (AM) LiDAR or time of flight (ToF) LiDAR.

To carry out a measurement with a ToF LiDAR sensor, i.e., a corresponding lidar system 2, one or several light pulses are emitted depending on the LiDAR model. The sensor receives these light pulses after reflection on a present object, and combines the light pulses in a LiDAR point cloud, described as a point cloud in the following, as is depicted in an exemplary form in FIG. 1 with reference to a side view of a traffic situation with the vehicle 3 comprising the lidar system 2 and a further vehicle F. A point cloud, i.e., a LiDAR point cloud, is a finite quantity of LiDAR points, in the following described as points p for short, which are described by a distance d, a location x, y, z and an intensity I.

As shown in FIG. 1, the lidar system 2, i.e., the lidar sensor, emits light pulses, which are reflected on objects they hit, in the example depicted here on the further vehicle F and on a road surface FO. Laser beams RLS reflected by the respective object are received by the lidar system 2, i.e., by the lidar sensor.

In recent years, lidar sensors, i.e., lidar systems 2, have become more important as a core modality for realizing automated, in particular highly automated or autonomous driving systems, i.e., vehicles 3. Lidar specifically has clear advantages in relation to other 3D sensors. An advantage in relation to a stereo camera is, for example, that a data quality from the generated lidar is not substantially influenced by daylight and darkness.

An expansion on the lidar is the multi-eye LiDAR system, described as a multi-eye lidar system in the following. The solution for recognizing the decalibration of the lidar system 2 described in the following relates to a lidar system 2 designed as such a multi-eye lidar system. In the multi-eye lidar system, several, i.e., at least two, laser receiver systems 2.1, 2.2, so-called eyes, are combined to form a lidar system 2. Scanning trajectories T1, T2 of the eyes, i.e., of the laser receiver systems 2.1, 2.2, are variable, as the measuring method is based on pivoting mirrors, unlike in classic rotating LiDAR sensors.

FIG. 2 shows a schematic depiction of the scan trajectory T1 of such a laser receiver system 2.1 of the lidar system 2, here scanning a flat surface EF.

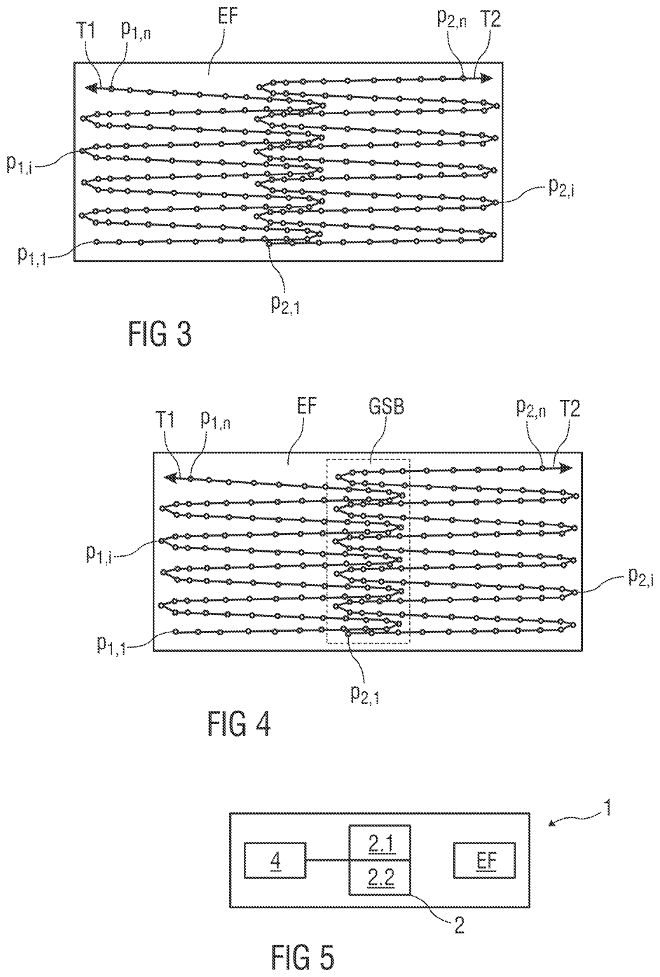

The scan trajectories T1, T2 of two or more eyes, i.e., laser receiver systems 2.1, 2.2, in a combined system, i.e., lidar system 2, are also described as a scan pattern. An example of a scan pattern of a lidar system 2, designed as a multi-eye lidar system, having two laser receiver systems 2.1, 2.2 is schematically depicted in FIG. 3, also when scanning a flat surface EF.

To use such a lidar system 2 as a reliable core modality in an automated, in particular highly automated or autonomous vehicle 3, a precision of the recorded point cloud from the lidar system 2 designed as a multi-eye lidar system is ensured. For this purpose, the scan trajectories T1, T2 of the eyes, i.e., of the laser receiver systems 2.1, 2.2, are synchronized before they are used. Due to a structure necessary for this purpose, the resulting scan trajectories T1, T2 of the eyes, i.e., of the laser receiver systems 2.1, 2.2, can for example change over time due to sensor-specific signs of ageing. A deviation must be determined for an interpretation of sensor data of the laser receiver systems 2.1, 2.2.

The solution described in the following relates to a technical method, which enables the scan trajectories T1, T2 to be checked without additional external sensors, and to a device 1 for carrying out this method.

The lidar system 2 to be checked by means of the method or of the device 1 with regard to a decalibration that may be present is designed, as already specified, as a lidar system 2 having several, i.e., at least two, laser receiver systems 2.1, 2.2 that have a shared viewing region GSB, also described as a multi-eye lidar system.

The lidar system 2 scans the environment, in particular the environment of the vehicle 3, with several, at least two, laser receiver systems 2.1, 2.2 in the shared viewing region GSB. It thus scans the environment, in particular the environment of the vehicle 3, with several laser beams in the shared viewing region GSB, wherein the respective laser beam is generated and emitted by the respective laser receiver system 2.1, 2.2 and reflected radiation of the respective laser beam, in particular caused by objects reflecting the laser beam, is received by receivers of the laser receiver system 2.1, 2.2. The respective laser receiver system 2.1, 2.2 is thus a laser transmitter-receiver system.

To enable the described scanning in the shared viewing region GSB, viewing regions of the individual laser receiver systems 2.1, 2.2 overlap at least in some regions, as shown in FIG. 4. Scan trajectories T1, T2 of two laser receiver systems 2.1, 2.2 of the lidar system 2 designed as a multi-eye lidar system are schematically depicted with the shared viewing region GSB, i.e., the region in which the viewing regions, and thus the scan trajectories T1, T2 of the laser receiver systems 2.1, 2.2 overlap. The overlap region in which the viewing regions of the individual laser receiver systems 2.1, 2.2 overlap thus forms the shared viewing region GSB. As already specified, the lidar system 2 comprises at least two or more than two such laser receiver systems 2.1, 2.2.

As described, the lidar system 2 thus scans the environment, in particular the environment of the vehicle 3, with several, i.e., at least two, laser receiver systems 2.1, 2.2, and thus with several, correspondingly at least two, laser beams, specifically with the laser beam of the respective laser receiver system 2.1, 2.2, in the shared viewing region GSB. To recognize a possible decalibration, a flat surface EF located in the shared viewing region GSB, for example a calibration target, a house wall or a traffic sign, is scanned with the laser receiver systems 2.1, 2.2, and thus with the several laser beams, specifically with the laser beam of the respective laser receiver system 2.1, 2.2. The point clouds are identified, which are created by the reflection of the respective laser beam on the flat surface EF. A virtual measuring surface, for example a B-spline plane or a Bezier plane, is interpolated by the identified point cloud of the respective laser beam, i.e., the respective virtual measuring surface is interpolated by means of all the points p_{1,i}, p_{2,i} of the respective identified point cloud. The respective virtual measuring surface thus advantageously runs through all the points p_{1,i}, p_{2,i} of the respective identified point cloud. It is determined whether the measuring surfaces determined for the respective laser beams substantially coincide with one another and/or are bent. If it is determined that the measuring surfaces do not substantially coincide with one another and/or that at least one of the measuring surfaces is bent, a decalibration of the lidar system 2 is deduced.

This flat surface EF is advantageously at least as large as the shared viewing region GSB of the laser receiver systems 2.1, 2.2. The flat surface EF is advantageously larger than the shared viewing region GSB of the laser receiver systems 2.1, 2.2, i.e., it advantageously protrudes completely over the shared viewing region GSB at the edge. The flat surface EF, and thus advantageously an object having the flat surface, and the lidar system 2 are or have been advantageously aligned with each other such that the shared viewing region GSB lies entirely on the flat surface EF, as shown in FIG. 4.

In a possible embodiment, to determine whether the respective measuring surface is bent, a tangential plane is determined on the respective measuring surface at each point p_{1,i}, p_{2,i} of the point cloud that determines this respective measuring surface. A tangential plane of this respective measuring surface is thus determined at each of these points p_{1,i}, p_{2,i} of the respective measuring surface, i.e., a plane abutting tangentially on the respective point p_{1,i}, p_{2,i} of the respective measuring surface on the respective measuring surface. A bent respective measuring surface is deduced, i.e., it is determined that the respective measuring surface is bent if the tangential planes determined for the different points p_{1,i}, p_{2,i} of the respective measuring surface do not substantially coincide with one another. As described above, a decalibration of the lidar system 2 is deduced already, i.e., such a decalibration of the lidar system 2 is recognized, if at least one of the measuring surfaces is bent, i.e., if the tangential planes determined for the different points p_{1,i}, p_{2,i} of this measuring surface do not substantially coincide with one another in at least one of the measuring surfaces.

The phrasing “substantially coincide with one another” used above should in particular be understood to mean that deviations that are potentially present lie within pre-determined tolerance limits, i.e., the measuring surfaces determined for the respective laser beams substantially coincide with one another if determined deviations lie within these pre-determined tolerance limits. If this is the case then the measuring surfaces determined for the respective laser beams are evaluated as at least substantially coinciding with one another. If deviations are determined that do not lie within these pre-determined tolerance limits, i.e., exceed these pre-determined tolerance limits, then the measuring surfaces determined for the respective laser beams are evaluated as not coinciding with another, and also as not substantially coinciding with one another.

After a decalibration of the lidar system 2 has been recognized, a calibration of the lidar system 2 can for example be carried out by the points (p_{1,i}, p_{2,i}) being adjusted to a shared plane by using a suitable model, i.e., such that all the points p_{1,i}, p_{2,i} of all the point clouds that are created in the shared viewing region GSB by the reflection of the respective laser beam of the laser receiver systems 2.1, 2.2 at the flat surface EF that is located in the shared viewing region GSB of the laser receiver systems 2.1, 2.2 and is scanned by these lie in a shared plane. A corresponding method for calibrating the lidar system 2, in particular the lidar system 2 of a vehicle 3, thus comprises the method described here for recognizing a decalibration of the lidar system 2, in particular the lidar system 2 of the vehicle 3, and additionally, when a decalibration of the lidar system 2 is recognized, its calibration is adjusted in the manner described above, i.e., the points p_{1,i}, p_{2,i} are adjusted to a shared plane, in particular in the manner described above, by using a suitable model.

FIG. 5 shows an exemplary schematic depiction of the device 1 for recognizing the decalibration of the lidar system 2, in particular of the lidar system 2 of the vehicle 3, in particular for carrying out the method described for recognizing the decalibration of the lidar system 2, in particular of the lidar system 2 of the vehicle 3. The device 1 can further also be designed or equipped to calibrate the lidar system 2, in particular the lidar system 2 of the vehicle 3, in particular to carry out the method for calibrating the lidar system 2. It then correspondingly comprises the device 1 for recognizing the decalibration of the lidar system 2, in particular of the lidar system 2 of the vehicle 3, and is additionally designed and equipped to calibrate the lidar system 2 in the manner described above when its decalibration is recognized, i.e., is designed and equipped to adjust the points p_{1,i}, p_{2,i} to a shared plane, in particular in the manner described above, by using a suitable model.

The device 1 comprises the lidar system 2 having the several, i.e., at least two, laser receiver systems 2.1, 2.2, and advantageously a processing unit 4, in particular for carrying out and evaluating at least one or several of the method steps described above or of all of the method steps described above.

The processing unit 4 can for example be a component of the lidar system 2, i.e., it can for example be a processing unit 4 present in any case that is also used for carrying out the method described here for recognizing the decalibration of the lidar system 2, in particular of the lidar system 2 of the vehicle 3, and for example additionally for carrying out the method described for calibrating the lidar system 2. The method described here for recognizing the decalibration of the lidar system 2 and for example additionally the method described for calibrating the lidar system 2 can thus for example be implemented in the lidar system 2.

In a possible embodiment, the device 1 can additionally comprise the flat surface EF, for example the calibration target.

In the following, the method for recognizing the decalibration of the lidar system 2 designed as a multi-eye lidar system, in particular the lidar system 2 of the vehicle 3, is described again in summary with reference to FIG. 4.

A flat surface EF, and thus for example an object having a flat side, i.e., having a surface without a bend, for example a calibration target or a façade of a building, i.e., a house wall, is required. The flat surface EF is advantageously larger than the shared viewing region GSB of the laser receiver systems 2.1, 2.2 of the lidar system 2, as shown in FIG. 4.

The flat surface EF, and thus advantageously the object having the flat surface EF, and the lidar system 2 are advantageously aligned with each other such that the shared viewing region GSB lies entirely on the flat surface EF.

FIG. 4 shows the scan trajectories T1, T2 of the two laser receiver systems 2.1, 2.2 of the lidar system 2 with the respective points p_{1,i}, p_{2,i}. The index “1” describes the association with the first scan trajectory T1 and the index “2” describes the association with the second scan trajectory T2, and the index “i” is the running index (i=1 to n).

The points p_{1,i} of the first scan trajectory T1, which lie in the shared viewing region GSB, are respectively an element of a quantity P1 of all the points p_{1,i} that belong to the first scan trajectory T1, and respectively an element of a quantity p_{GsB} of all the points p_{1,i}, p_{2,i} that lie in the shared viewing region GSB. If a respective point p_{1,i} of the first scan trajectory T1 does not lie in the shared viewing region GSB, it is only one element of the quantity P1.

The points p_{2,i} of the second scan trajectory T2, which lie in the shared viewing region GSB, are respectively an element of a quantity P2 of all the points p_{2,i} that belong to the second scan trajectory T2, and respectively an element of the quantity p_{GsB} of all the points p_{1,i}, p_{2,i} that lie in the shared viewing region GSB. If a respective point p_{2,i} of the second scan trajectory T2 does not lie in the shared viewing region GSB, it is only one element of the quantity P2.

A surface E1, i.e., a measuring surface E1, in space that describes bends, for example a B-spline surface or Bezier surface, is determined for the points p_{1,i} that belong to the quantity P1 and to the quantity p_{GSB}, i.e., for all the points p_{1,i} of the first scan trajectory T1 that lie in the shared viewing region GSB.

A surface E2, i.e., a measuring surface E2, in space that describes bends, for example a B-spline surface or Bezier surface, is determined for the points p_{2,i} that belong to the quantity P2 and to the quantity p_{GSB}, i.e., for all the points p_{2,i} of the second scan trajectory T2 that lie in the shared viewing region GSB.

The respective tangential plane of the surface E1 is determined at each point p_{1,i} of the first scan trajectory T1 that lies in the shared viewing region GSB.

### There are Two Possible Cases:

Case a: the surface E1 has different tangential planes at the different points p_{1,i} of the first scan trajectory T1 that lie in the shared viewing region GSB. It is then recognized and for example reported that an, in particular intrinsic, decalibration of this laser receiver system 2.1 has been observed, and thus the, in particular intrinsic, decalibration of the lidar system 2 is also recognized and for example reported.

Case b: the surface E1 has the same tangential plane at the different points p_{1,i} of the first scan trajectory T1 that lie in the shared viewing region GSB, and is thus a plane as expected in a non-decalibrated lidar system 2.

The respective tangential plane of the surface E2 is determined at each point p_{2,i} of the second scan trajectory T2 that lies in the shared viewing region GSB.

### There are Two Possible Cases:

Case a: The surface E2 has different tangential planes at the different points p_{2,i} of the second scan trajectory T2 that lie in the shared viewing region GSB. It is then recognized and for example reported that an, in particular intrinsic, decalibration of this laser receiver system 2.2 has been observed, and thus the, in particular intrinsic, decalibration of the lidar system 2 is also recognized and for example reported.

Case b: the surface E2 has the same tangential plane at the different points p_{2,i} of the second scan trajectory T2 that lie in the shared viewing region GSB, and is thus a plane as expected in a non-decalibrated lidar system 2.

If case b occurs for both of the surfaces E1 and E2, i.e., if it is determined both that the surface E1 has the same tangential plane at the different points p_{1,i} of the first scan trajectory T1 that lie in the shared viewing region GSB and is thus a plane, and it is also determined that the surface E2 has the same tangential plane at the different points p_{2,i} of the second scan trajectory T2 that lie in the shared viewing region GSB and is thus a plane, the surfaces E1 and E2 are checked for similarity. If the surfaces E1 and E2 are the same, advantageously with regard to a known noise of the lidar system 2, the noise for example being shared by a producer of the lidar system 2, then the lidar system 2, in particular with regard to the laser receiver systems 2.1, 2.2, is calibrated, in particular calibrated intrinsically. If the surfaces E1 and E2 are not the same, the laser receiver systems 2.1, 2.2 are decalibrated, in particular intrinsically, and the lidar system 2 is thus also decalibrated, in particular intrinsically.

1.-7. (canceled)

8. A method for recognizing a decalibration of a lidar system (2) of a vehicle (3), comprising the steps of:
scanning an environment by the lidar system (2) with a plurality of laser receiver systems (2.1, 2.2) in a shared viewing region (GSB);
scanning a flat surface (EF) located in the shared viewing region (GSB) with the plurality of laser receiver systems (2.1, 2.2);
identifying point clouds that are created by a reflection of a respective laser beam of the plurality of laser receiver systems (2.1, 2.2) on the flat surface (EF);
interpolating a virtual measuring surface by the identified point cloud of the respective laser beam;
determining whether the virtual measuring surfaces for the respective laser beams substantially coincide with one another and/or are bent; and
deducing a decalibration of the lidar system (2) when it is determined that the virtual measuring surfaces for the respective laser beams do not substantially coincide with one another and/or that at least one of the virtual measuring surfaces for the respective laser beams is bent.

9. The method according to claim 8, wherein to determine whether the respective virtual measuring surface is bent, a tangential plane is determined on the respective measuring surface at each point (p_{1,i}, p_{2,i}) of the point cloud that determines this respective measuring surface and wherein a respective bent measuring surface is deduced when the tangential planes determined at each point (p_{1,i}, p_{2,i}) of the respective measuring surface substantially do not coincide with one another.

10. The method according to claim 8, wherein an environment of the vehicle (3) is scanned as the environment.

11. The method according to claim 8, wherein a calibration target, a house wall, or a traffic sign is used as the flat surface (EF).

12. The method according to claim 8, wherein a B-spline plane or Bezier plane is interpolated as a virtual measuring surface.

13. An apparatus for recognizing a decalibration of a lidar system (2) of a vehicle (3), wherein the lidar system (2) has a plurality of laser receiver systems (2.1, 2.2) that are configured to scan an environment in a shared viewing region (GSB), comprising:
a device (1) configured to:
scan a flat surface (EF) located in the shared viewing region (GSB) with the plurality of laser receiver systems (2.1, 2.2);
identify point clouds that are created by a reflection of a respective laser beam of the plurality of laser receiver systems (2.1, 2.2) on the flat surface (EF);
interpolate a virtual measuring surface with the identified point cloud of the respective laser beam;
determine whether the virtual measuring surfaces for the respective laser beams substantially coincide with one another and/or are bent; and
deduce a decalibration of the lidar system (2) when it is determined that the virtual measuring surfaces for the respective laser beams do not substantially coincide with one another and/or that at least one of the virtual measuring surfaces for the respective laser beams is bent.

14. The apparatus according to claim 13, wherein to determine whether the respective measuring surface is bent, the device (1) is configured to determine a tangential plane on the respective measuring surface at each point (p_{1,i}, p_{2,i}) of the point cloud that determines this respective measuring surface, and to deduce a bent respective measuring surface, and thus a decalibration of the lidar system (2), when the tangential planes determined at each point (p_{1,i}, p_{2,i}) of the respective measuring surface do not substantially coincide with one another.
